(19) United States
(12) Patent Application Publication
(10) Pub. No.: US 2026/0045825 A1
(43) Pub. Date: Feb. 12, 2026

(54) MODULAR DEVICE FOR REMOTE MONITORING AND CONTROL OF INDIVIDUAL DIRECT CURRENT (DC) CIRCUITS

(71) Applicant: VERTIV CORPORATION, Westerville, OH (US)

(72) Inventors: Timothy B. Strouse, North Ridgeville, OH (US); Michael F. Smith, Columbia Station, OH (US); Paul B. Hiidel, Strongsville, OH (US); David J. Michlovic, Avon Lake, OH (US)

(21) Appl. No.: 19/286,519

(22) Filed: Jul. 31, 2025

Related U.S. Application Data
(60) Provisional application No. 63/679,899, filed on Aug. 6, 2024.

(51) Int. Cl. H02J 13/00; H02J 1/10

(52) U.S. Cl. CPC H02J 13/00002; H02J 1/10; H02J 13/00007; H02J 13/00026; H02J 13/00036

(57) ABSTRACT

A modular remote current monitoring device plugs into a single-pole mounting location on a power distribution panel of a direct-current (DC) power system, e.g., where a circuit breaker, fuse, shorting device, or other target device would ordinarily be installed. The target device plugs into the modular device (e.g., via bullet-type connectors) such that an individual (e.g., single-pole) current is conveyed between the power distribution panel and the target device via the modular device. The modular device senses an amperage of the individual current and reports the sensed amperage to a remotely located end user or controller. The end user or controller similarly may interrupt (disable) or reset (enable) the current from a remote location via the modular device.

### CROSS-REFERENCE TO RELATED APPLICATIONS

The present application claims the benefit under 35 U.S. C. § 119(e) of U.S. Provisional Patent Application Ser. No. 63/679,899 filed Aug. 6, 2024, titled MODULAR DEVICE FOR REMOTE MONITORING AND CONTROL OF INDIVIDUAL LOAD CIRCUITS. Said U.S. Provisional Patent Application 63/679,899 is incorporated herein by reference in its entirety.

### TECHNICAL FIELD

The present disclosure is directed to direct-current (DC) power systems and more particularly to monitoring and control of DC circuits.

### BACKGROUND

Direct-current (DC) power systems provide operating power to a variety of end users through power distribution panels (e.g., power distribution boards), whereby input power provided by one or more DC sources is distributed to end-user loads. Conventionally, the DC power system control unit measures only the source or output current for the entire distribution panel, as opposed to individual sources or individual currents associated with each end-user. Some DC power systems provide for multi-pole breakers or large fuses with shunts, which are mounted to inputs and outputs of the power distribution panel via busbar connections occupying multiple mounting positions (and, e.g., multiple overcurrent protection devices). Here too, only the current to and from the busbar is measurable, rather than individual currents. Further, in addition to not being individually measurable, the currents are not individually controllable. For example, radios or other like equipment may be located on towers or other remote locations and, in the event of a lockup, a site visit is required to power cycle and reset the equipment. Under other certain circumstances (e.g., power outages, increases or decreases in the current corresponding to an individual breaker), it is desirable to enable or disable individual circuits, either directly or remotely.

### SUMMARY

In a first aspect, a modular device for remote monitoring and control of direct-current (DC) circuits is disclosed. In embodiments, the modular device includes a housing and terminal extending from a face of the housing. For example, the terminal connectors allow the modular device to plug into a power distribution panel (e.g., at a distribution position or mounting point where a target device would ordinarily plug in). Opposite the terminal connectors, the device includes a set of receptacles allowing the target device to plug into the modular device instead of into the power distribution panel. Within the housing, the device includes circuitry for conveying a current (e.g., load current, source current) between the power distribution panel (to which the device is plugged into) and the target device (plugged into the device). The circuitry also (periodically or continually) senses amperage of the current through the circuit.

In some embodiments, the terminal connectors are bullet-type connectors, and the terminal receptacles are configured to accept bullet-type connectors (e.g., of the target device).

In some embodiments, the target device is an overcurrent protection device such as a circuit breaker device or a fuse set into a fuseholder.

In some embodiments, the target device is a bypass busbar or other shorting device without overcurrent protection.

In some embodiments, the receptacles set into the modular device include alarm receptacles configured to accept alarm contacts of the target device.

In some embodiments, the modular device includes a communications interface capable of providing a communications link from the modular device to a remotely located user or a power system controller (e.g., a controller associated with the power distribution panel, where the panel is part of a DC power distribution system), e.g., for transmission of the sensed amperage.

In some embodiments, the communications interface receives control input from the user via the communications link. For example, based on the received control input, the circuitry can disable the circuit or reset/enable the circuit (e.g., if previously disabled).

In some embodiments, based on the received control input, the circuitry sets a threshold for the sensed amperage.

In some embodiments, the circuitry disables the circuit when the sensed amperage reaches or exceeds the set threshold.

In some embodiments, the communications link includes an intermediate communications device, e.g., plugged into the modular device or into the target device (if said target device is plugged into the modular device). For example, the intermediate communications device may provide an interface to the modular device and a link connecting the modular device to the end user and/or controller.

In some embodiments, the communications link is either an indirect or direct link (e.g., with or without the intermediate communications device respectively) via one or more of a wireless link or a physical/wired link, e.g., hard-wired cable or power line carrier (PLC).

In a further aspect, a method for remote monitoring of a DC circuit is disclosed. In embodiments, the method includes inserting one or more terminal connectors (e.g., bullet-type connectors) of a modular current monitoring and control device into an input (e.g., mounting position) for a power distribution panel. The method includes inserting a target having bullet-type connectors into terminal receptacles of the modular device. The method includes conveying a current between the power distribution panel and the target device via the modular device. The method includes sensing an amperage of the current (e.g., continually, periodically) via the modular device. The method includes transmitting the sensed amperage to a remotely located user (or a power system controller) via a communications interface of the modular device.

In some embodiments, the target device includes a fuse, breaker, or other overcurrent protection device.

In some embodiments, the target device may be a bypass busbar or other shorting device without overcurrent protection.

In some embodiments, the method includes transmitting the sensed amperage via an intermediate communications device plugged into the modular device (or into the target device, where said target device is plugged into the modular device).

In some embodiments, the method includes transmitting the sensed amperage via a wireless network link, e.g., with or without the intermediate communications device.

In some embodiments, the method includes receiving control input from a user or power system controller, e.g., via a communications interface of the modular device.

In some embodiments, the method includes disabling the current or the associated circuit based on the received control input.

In some embodiments, the method includes resetting or enabling the circuit associated with the current based on the received control input.

In some embodiments, the method includes setting a threshold current level based on the control input, and disabling the current when the current exceeds the threshold level.

This Summary is provided solely as an introduction to subject matter that is fully described in the Detailed Description and Drawings. The Summary should not be considered to describe essential features nor be used to determine the scope of the Claims. Moreover, it is to be understood that both the foregoing Summary and the following Detailed Description are example and explanatory only and are not necessarily restrictive of the subject matter claimed.

### BRIEF DESCRIPTION OF THE DRAWINGS

The detailed description is described with reference to the accompanying figures. The use of the same reference numbers in different instances in the description and the figures may indicate similar or identical items. Various embodiments or examples (“examples”) of the present disclosure are disclosed in the following detailed description and the accompanying drawings. The drawings are not necessarily to scale. In general, operations of disclosed processes may be performed in an arbitrary order, unless otherwise provided in the claims. In the drawings:

FIG. 1 is a block diagram of a DC power system architecture including a power distribution panel, individual target devices connected thereto, and modular remote current monitoring and control devices according to example embodiments of this disclosure;

FIG. 2 is an illustration in rear isometric and profile views of a modular device as shown by FIG. 1;

FIG. 3 is an illustration of the modular device of FIG. 1 implemented with the power distribution panel of FIG. 1 according to example embodiments of this disclosure;

FIG. 4 is an exploded illustration of the modular device of FIG. 1 implemented in the DC power system architecture of FIG. 1 according to example embodiments of this disclosure;

and FIGS. 5A through 5C are process flow diagrams illustrating a method for remote monitoring and control of individual DC currents according to example embodiments of this disclosure.

### DETAILED DESCRIPTION

Before explaining one or more embodiments of the disclosure in detail, it is to be understood that the embodiments are not limited in their application to the details of construction and the arrangement of the components or steps or methodologies set forth in the following description or illustrated in the drawings. In the following detailed description of embodiments, numerous specific details may be set forth in order to provide a more thorough understanding of the disclosure. However, it will be apparent to one of ordinary skill in the art having the benefit of the instant disclosure that the embodiments disclosed herein may be practiced without some of these specific details. In other instances, well-known features may not be described in detail to avoid unnecessarily complicating the instant disclosure.

As used herein a letter following a reference numeral is intended to reference an embodiment of the feature or element that may be similar, but not necessarily identical, to a previously described element or feature bearing the same reference numeral (e.g., 1, 1a, 1b). Such shorthand notations are used for purposes of convenience only and should not be construed to limit the disclosure in any way unless expressly stated to the contrary.

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of “a” or “an” may be employed to describe elements and components of embodiments disclosed herein. This is done merely for convenience and “a” and “an” are intended to include “one” or “at least one,” and the singular also includes the plural unless it is obvious that it is meant otherwise.

Finally, as used herein any reference to “one embodiment” or “some embodiments” means that a particular element, feature, structure, or characteristic described in connection with the embodiment is included in at least one embodiment disclosed herein. The appearances of the phrase “in some embodiments” in various places in the specification are not necessarily all referring to the same embodiment, and embodiments may include one or more of the features expressly described or inherently present herein, or any combination or sub-combination of two or more such features, along with any other features which may not necessarily be expressly described or inherently present in the instant disclosure.

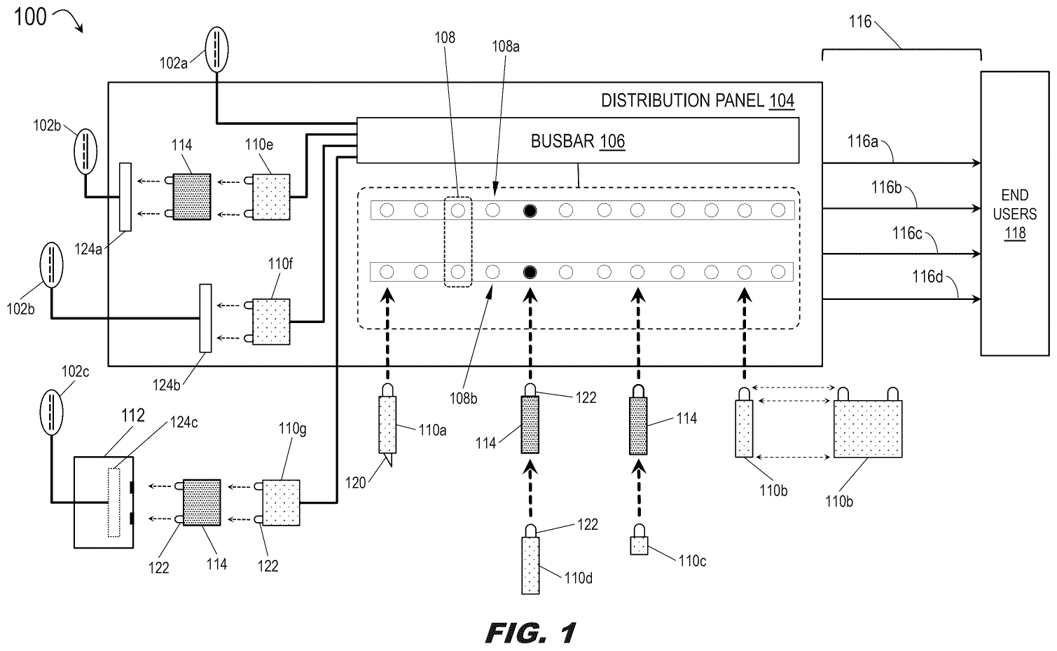

### FIG. 1—Power System Architecture

Broadly speaking, embodiments of the inventive concepts disclosed herein are directed to a modular device and method for remote monitoring and remote control of individual direct-current (DC) circuits in a DC power distribution system.

Referring to FIG. 1, a DC power system 100 is shown. The DC power system 100 may include a power source 102a-102c (e.g., DC source, grid source), power distribution panel 104, busbar 106, distribution positions 108 (e.g., mounting positions), target devices 110, source disconnect box 112 (e.g., source disconnect panel), and modular remote monitoring and control device 114.

In embodiments, the power distribution panel 104 may provide DC operating power in the form of current loads 116 (e.g., DC output loads, output currents) to a variety of end users 118 (e.g., consumers). For example, current loads 116a may be associated with a first end user 118, current loads 116b with a second end user, current load 116c with a third end user, and current load 116d with a fourth end user. In embodiments, the current loads 116a, 116b, 116c may respectively be associated with target devices 110a, 110b, 110c insertable into distribution positions 108 of the power distribution panel 104. For example, target devices 110 may include circuit breaker devices or fuses in fuseholders, the breaker devices and fuseholders insertable into distribution positions 108 on the power distribution panel 104 for resettable, one-time, or continual use respectively. In some embodiments, a target device 110a may include an interrupt switch 120, e.g., for manual interruption or disabling of a current load 116a associated with the target device (e.g., when directly activated by an end user 118).

In some embodiments, the modular device 114 may be inserted directly into a distribution position 108 of the power distribution panel 104, e.g., via terminal connectors 122 (e.g., bullet-type connectors having a substantially hemispherical or hemispheroidal shape). For example, each distribution position 108 may include a load-side terminal receptacle 108a and a line-side terminal receptacle 108b, each terminal receptable capable of accepting a terminal connector 122.

In some embodiments, the target device 110c may include a shorting device without overcurrent protection, e.g., a bypass busbar inserted into the modular device 114 via terminal connectors 122, wherein the modular device is in turn inserted into a distribution position 108.

In embodiments, the current load 116d may be associated with a target device 110d inserted into the modular device 114, the modular device in turn inserted into a distribution position 108 of the power distribution panel 104 (e.g., where the target device 110d would otherwise connect), also via terminal connectors 122. For example, the modular device 114 may provide for remote monitoring and/or control (e.g., enabling/connection, disabling/interrupting) of the current load 116d associated with the target device 110d, as described below.

In embodiments, the power distribution panel 104 may be fed DC operating power in the form of current from various power sources 102a-102c (e.g., grid sources converted to DC by rectifiers, DC generators, batteries, other DC power system distribution panels, etc.). For example, source 102a may feed directly into the power distribution panel 104. Further, source 102b may feed busbar connectors 124a, 124b within the power distribution panel 104. Further, source 102c may feed busbar connector 124c within the source disconnect box 112 before feeding the power distribution panel 104.

In embodiments, source 102b may be associated with target devices 110e, 110f and busbar connectors 124a, 124b respectively, via separate battery strings inserted directly into the power distribution panel 104, e.g., via bullet-type or other appropriate terminal connectors 122. Further, the source current 102b (e.g., separate battery strings connected to target devices 110e, 110f) is not individually measurable or controllable by its end user 118.

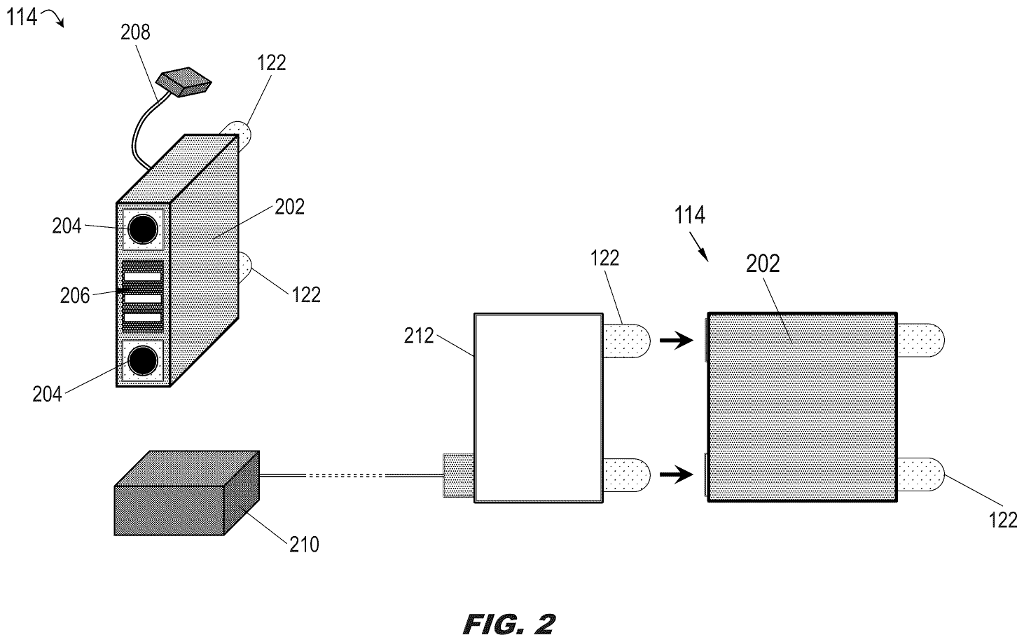

In embodiments, the source current 102b may be associated with the target device 110e (e.g., separate battery string) inserted into a modular device 114, the modular device in turn inserted into a distribution position 108 of the power distribution panel 104 (e.g., where the target device 110e would otherwise connect), also via terminal connectors 122. For example, the modular device 114 may provide for remote monitoring and/or control (e.g., enabling/connection, disabling/interrupting) of the source current 102b (in this case a separate battery string) associated with the target device 110e, as described below in FIGS. 2 through 5.

In embodiments, the source current 102c may be associated with a target device 110g inserted into a modular device 114, the modular device in turn inserted into a distribution position (e.g., busbar connector 124c) of the source disconnect box 112 (e.g., where the target device 110g would otherwise connect), also via terminal connectors 122. For example, the modular device 114 may provide for remote monitoring and/or control (e.g., enabling/connection, disabling/interrupting) of the source current 102c associated with the target device 110g, as described below.

### FIG. 2—Modular Device Detail

Referring now to FIG. 2, the modular device 114 is shown.

In embodiments, the modular device 114 may include a housing 202, e.g., fashioned of material similar to the target devices (110, 110a-110g, FIG. 1), enclosing circuitry as described below. Further, the modular device 114 may include terminal connectors 122, e.g., bullet-type connectors, extending from the housing 202 (e.g., from a forward face of the housing). For example, the modular device 114 may connect to a distribution position (108, FIG. 1) of the power distribution panel (104, FIG. 1) or source disconnect box (112, FIG. 1) via the terminal connectors 122. In embodiments, the modular device 114 may also include a return lead 208.

In embodiments, the modular device 114 may include receptacles set into the housing 202, e.g., into a rearward face opposite the terminal connectors 122. For example, the modular device 114 may include a pair of terminal receptacles 204, the terminal receptacles capable of accepting terminal connectors (122, FIG. 1; e.g., bullet-type connectors) of a target device 110 (e.g., controlled by interrupt switch 120) as described below. The modular device 114 may further include alarm terminal slots 206 set into the housing 202 and capable of accepting alarm contacts (e.g., relay contacts, Form-C relay contacts) of the target device 110.

In some embodiments, the modular device 114 may communicate (e.g., transmit a sensed amperage) with one or more of an end user 118 or a controller of the DC power system 100. For example, the modular device 114 may communicate end user 118 or DC power system controller 210 via an intermediate communication device 212. In embodiments, the intermediate communication device 212 may likewise include terminal connectors 122 pluggable into the terminal receptacles 204 of the modular device 114 (or into a target device 110, 110a-110g (see FIG. 1), if said target device is plugged into the modular device). Further, the intermediate communication device 212 may communicate with the DC power system controller 210 via hard-wired cable (e.g., compatible with CANbus, RS-485 Modbus, or other appropriate communications protocol). Alternatively, communications between the intermediate communication device 212 and DC power system controller 210 may be wireless or via power line carrier (PLC) communications protocols, e.g., or any other appropriate communications protocol not requiring additional wiring. In some embodiments, the modular device 114 may communicate with end users 118 and/or the DC power system controller 210 directly, without the use of an intermediate communication device 212. For example, direct communications between the modular device 114 and end users 118/DC power system controller 210 may be via hard-wired cable as described above, or in the alternative may include wireless and/or PLC-based communications protocols.

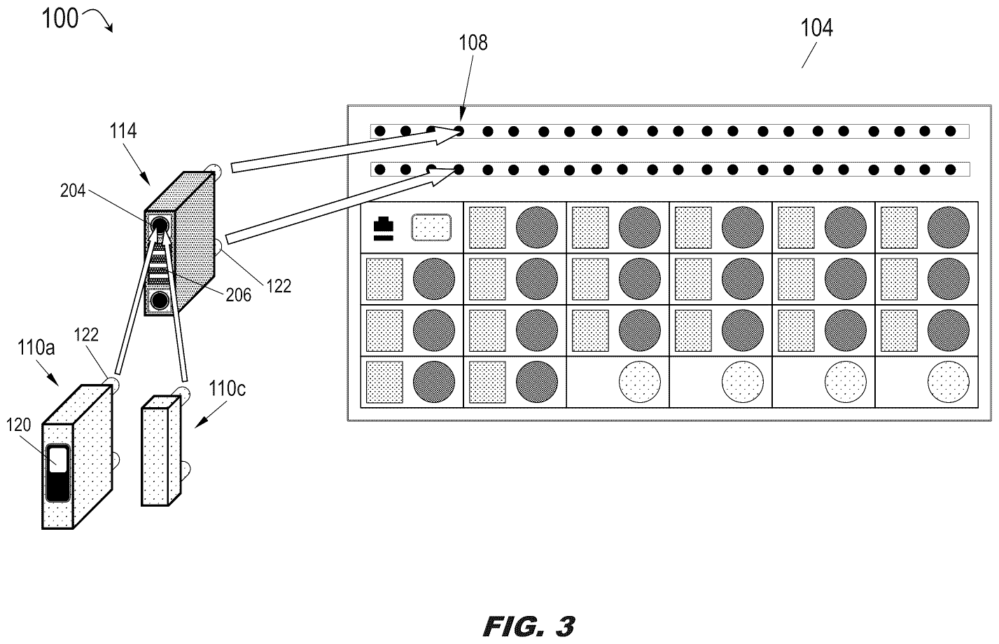

### FIG. 3—Modular Device Installation

Referring also to FIG. 3, the DC power system 100 is shown.

In embodiments, the modular device 114 may electrically connect to the power distribution panel 104 by plugging (e.g., via the terminal connectors 122) into a distribution position 108 of the power distribution panel. Similarly, the target device 110 (e.g., target device 110a with interrupt switch 120, shorting device 110c, other target devices 110b, 110d-110g as shown by FIG. 1) may electrically connect to the modular device 114, e.g., by plugging its terminal connectors 122 into the terminal receptacles 204 of the modular device (and, e.g., its alarm contacts into the alarm terminal slots 206 of the modular device).

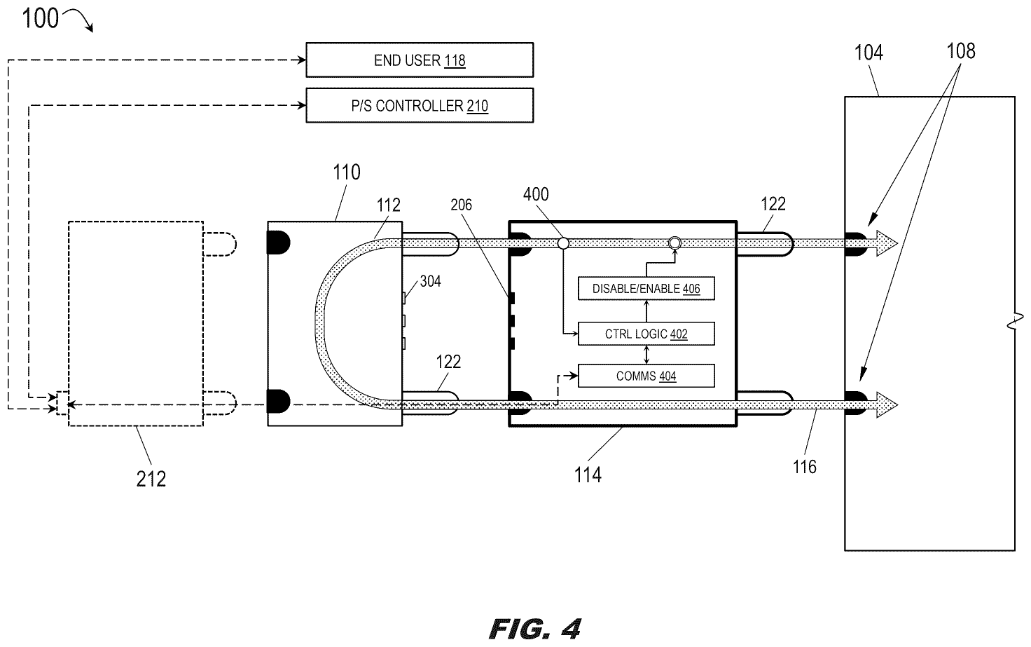

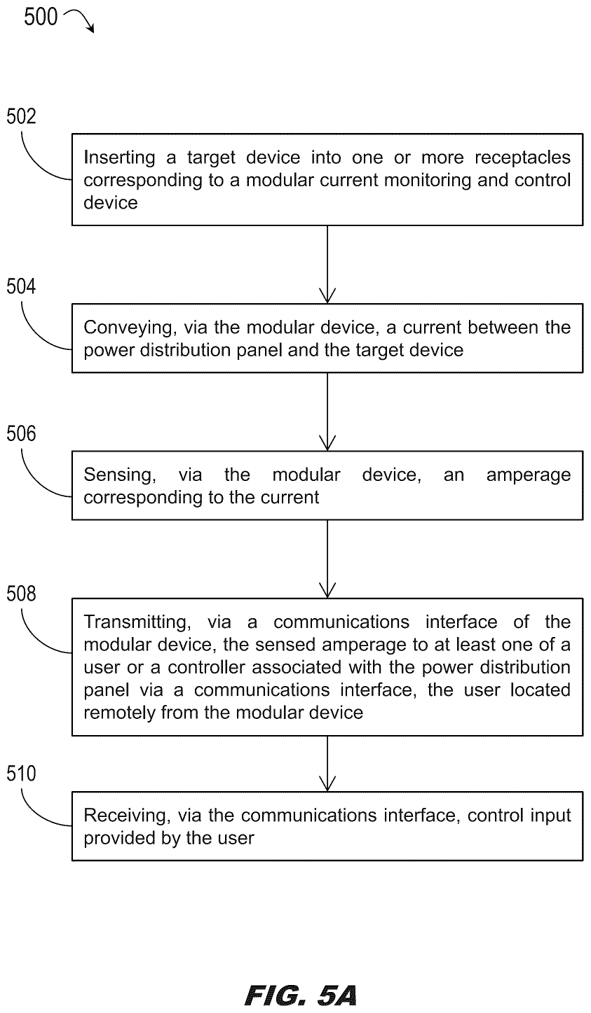

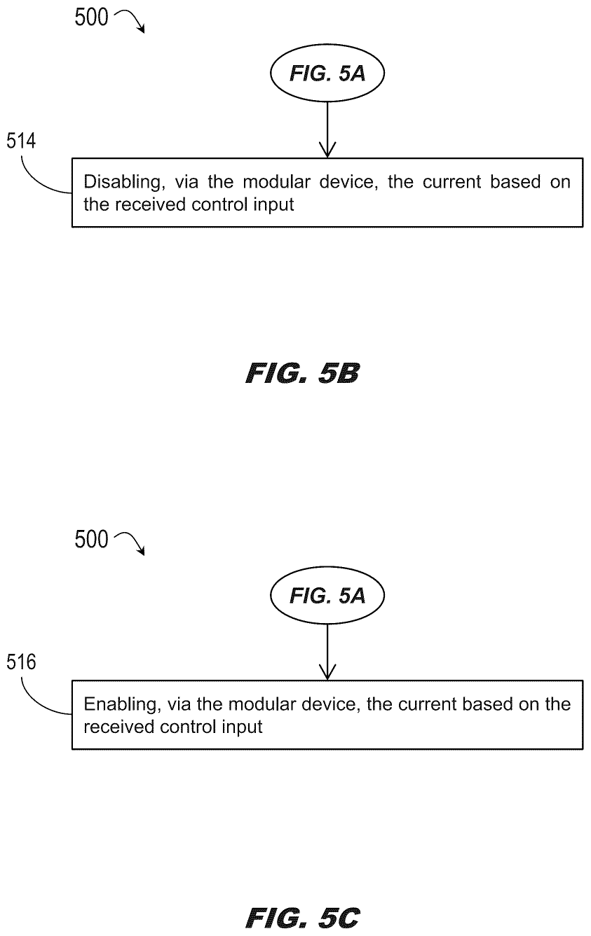

### FIG. 4—Modular Device, Schematic

Referring now to FIG. 4, the DC power system 100 is shown.

In embodiments, when the modular device 114 is plugged into a distribution position 108 of the power distribution panel 104 (e.g., via terminal connectors 122), and the target device 110 (110a-110g; see FIG. 1) is plugged into the modular device 114 (e.g., via terminal connectors 122 and/or alarm contacts 304), the modular device 114 may convey (e.g., conduct) a current 116 (also source current/s 102a-102c, FIG. 1) between the power distribution panel 104 and the target device 110. For example, the target device 110 may still be capable of manual interruption of the current 116, 102a-102c, e.g., via the interrupt switch 120 (see FIG. 1).

In embodiments, the modular device 114 may include a current sensor 400 for monitoring the rate (e.g., amperage) of the current 116, 102a-102c. For example, the current sensor 400 may continually or periodically measure the amperage of the current 116, 102a-102c according to a predetermined interval set by control logic 402.

In embodiments, the modular device 114 may include a communications interface 404 for data exchange with an end user 118 or controller 210 of the DC power system 100. For example, the DC power system controller 210 may include one or more control processors capable of accepting control input from the end user. Further, the end user 118 may interface with the DC power system controller 210 via, physical interface or wireless communication, e.g., via Bluetooth or like communications protocol whereby control input is provided through an application running on a mobile device or similar computing device of the end user. For example, the communications interface 404 may transmit sensed amperages to the end user 118 or controller, either directly or indirectly as described above, e.g., in FIG. 2. For example, the communications interface 404 may communicate indirectly, e.g., via an intermediate communication device 212 plugged into the modular device 114 or target device 110, or directly with the end users 118 and/or DC power system controller 210. In embodiments, the direct or indirect connection between the communications interface 404 and end users 118/DC power system controller 210, and/or between the communications interface 404 and the modular device 114, may include hard-wired cable (e.g., compatible with CANbus, RS-485 Modbus, or other appropriate protocols), physical/wired network, wireless networks and/or protocols, power line carrier (PLC) based communications, or other appropriate protocols not requiring additional wiring as described above. For example, where interference and/or noise associated with wireless communication is not an issue, the communications interface 404 may provide for transmission of sensed flow rates to the end user 118 or DC power system controller 210 via Bluetooth or other appropriate wireless communications protocol (e.g., Bluetooth). Similarly, when the connection between the communications interface 404 and end user 118/DC power system controller 210 is indirect, i.e., includes the intermediate communications device 212, the connection between the intermediate communications device and the communications interface of the modular device 114 may be hard-wired.

In embodiments, the communications interface 404 may additionally accept control input provided by the remotely located end user 118. For example, based on received current amperages sensed and sent by the modular device 114, the end user 118 may direct the modular device (e.g., via control logic 402) to disable (406) the current 116, 102a-102c (if the sensed amperage significantly increases or exceeds a threshold level, or at the discretion of the end user). Similarly, if the current 116, 102a-102c is currently disabled, the end user 118 may direct the modular device 114 to reset or enable (406) the current 116, 102a-102c.

In some embodiments, the end user 118 may set a preprogrammed threshold amperage level via the control logic 402. For example, should the sensed amperage of the current 116, 102a-102c meet or exceed the threshold level, the modular device 114 may automatically disable (406) the current and/or trigger an alarm.

### FIGS. 5a Through 5c—Method

Referring now to FIG. 5A, the method 500 may be implemented by the DC power system 100 and may include the following steps.

At a step 502, a target device is inserted into the modular device, e.g., also via bullet-type terminal connector and compatible terminal receptacles set into the modular device. In some embodiments, the target device is a fuse, circuit breaker, or other overcurrent protection device. In some embodiments, the target device is a shorting device without overcurrent protection.

At a step 504, the modular device conveys a current associated with the target device (e.g., load current, source current, associated with a particular end user or controller) between the power distribution panel and the target device.

### At a Step 506, the Modular Device Senses an Amperage of the Current.

At a step 508, the modular device transmits the sensed amperage to an end user located remotely from the power system, or to a power system controller. In some embodiments, the sensed amperage is transmitted via hard-wired cable, via power-line carrier, or via wireless link. In some embodiments, the sensed amperage is transmitted via an intermediate communication device plugged into the modular device or target device, e.g., if said target device is plugged into the modular device.

In some embodiments, the method 500 includes an additional step 510. At the step 510, the modular device receives control input from the end user (e.g., either directly or via the intermediate communications device).

Referring also to FIG. 5B, in some embodiments the method 500 includes an additional step 512. At the step 512, the modular device disables the current based on the received control input (e.g., if the sensed amperage exceeds a threshold level or significantly increases).

Referring also to FIG. 5C, in some embodiments the method 500 includes an additional step 514. At the step 514, the modular device resets or enables the current (e.g., if the current is currently interrupted or disabled, or at the discretion of the end user) based on the received control input.

### Conclusion

It is contemplated that the system may have numerous advantages. For example, embodiments of the inventive concepts disclosed herein may provide a higher degree of granularity for end users in that it may be possible to remotely receive measurements of individual DC currents corresponding to target devices, rather than the output current associated with the distribution panel as a whole or with a multi-pole busbar configuration. Further, end users may individually adjust each current (e.g., via disabling or enabling current flow) in either direction for more efficient power usage and/or battery usage. For example, end users may be able to plan for future network deployments with minimal disruption to the rest of the system. Power system controllers and/or managers may more effectively monitor end user customers sharing the system. In response to outages, individual shedding of non-critical loads can lengthen backup time for critical loads, release stranded capacity when available or needed, and reset equipment (all remotely). The modular device and method are compatible with next-generation and legacy power systems alike, and with a broad variety of target devices.

Those having skill in the art will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be implemented (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be implemented, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and/or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, etc.).

In a general sense, those skilled in the art will recognize that the various aspects described herein which can be implemented, individually and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment). Those having skill in the art will recognize that the subject matter described herein may be implemented in an analog or digital fashion or some combination thereof.

Those having skill in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. Furthermore, it is to be understood that the invention is defined by the appended claims.

We claim:

1. A modular device for monitoring direct-current (DC) circuits, comprising:
a housing;
at least one first terminal connector extending from a first face of the housing, the at least one terminal connector configured for electrically coupling the modular device to a power distribution panel via insertion into at least one input of the power distribution panel;
a plurality of receptacles set into a second face of the housing, the second face opposite the first face, the plurality of receptacles configured for electrically coupling the modular device to a target device and including at least one terminal receptacle configured to receive a terminal connector of the target device;
circuitry disposed within the housing and electrically coupled to the at least one first terminal connector and to the at least one terminal receptacle, the circuitry configured to:
convey a current between the power distribution panel and the target device;
and
sense an amperage of the current.

2. The modular device of claim 1, wherein the at least one terminal connector includes at least one bullet type connector.

3. The modular device of claim 1, wherein the target device includes at least one overcurrent protection device, the overcurrent protection device including at least one of a fuse or a circuit breaker.

4. The modular device of claim 1, wherein the target device includes at least one shorting device.

5. The modular device of claim 1, wherein the plurality of receptacles includes at least one alarm receptacle configured to receive an alarm contact of the target device.

6. The modular device of claim 1, wherein the modular device includes a communications interface disposed within the housing, the communications interface configured to:
provide a communications link between the modular device and at least one of a user or a controller associated with the power distribution panel;
and
transmit the sensed amperage to the user or controller via the communications link.

7. The modular device of claim 6, wherein:
the communications interface is configured to receive control input from the user or controller via the communications link;
and
wherein the circuitry is configured to:
disable the current based on the received control input;
and enable the current based on the received control input.

8. The modular device of claim 7, wherein the circuitry is configured to set a threshold amperage corresponding to the current based on the received control input.

9. The modular device of claim 8, wherein the circuitry is configured to disable the current when the sensed amperage exceeds the threshold amperage.

10. The modular device of claim 6, wherein:
the communications interface is configured to engage with an intermediate communications device insertable into one of the modular device or the target device.

11. The modular device of claim 6, wherein the communications link includes at least one of:
a wireless communications link;
or
a physical communications link including one or more of a hard-wired cable or a power line carrier (PLC) communications link.

12. A method for remote monitoring of a direct-current (DC) circuit, the method comprising:
inserting a target device into one or more receptacles corresponding to a modular current monitoring and control device;
conveying, via the modular device, a current between a power distribution panel and the target device;
sensing, via the modular device, an amperage corresponding to the current;
and
transmitting, via a communications interface of the modular device, the sensed amperage to at least one of a user or a controller associated with the power distribution panel via a communications interface, the user located remotely from the modular device.

13. The method of claim 12, wherein inserting a target device into one or more receptacles corresponding to the modular device includes:
inserting an overcurrent protection device into the one or more receptacles, the overcurrent protection device including one of a fuse or a circuit breaker.

14. The method of claim 12, wherein inserting a target device into one or more receptacles corresponding to the modular device includes:
inserting a shorting device into the one or more receptacles.

15. The method of claim 12, wherein transmitting, via a communications interface of the modular device, the sensed amperage to a user via a communications network includes:
transmitting the sensed amperage via an intermediate communications device inserted into one of the target device or the modular device.

16. The method of claim 12, wherein transmitting, via a communications interface of the modular device, the sensed amperage to a user via a communications network includes:
transmitting the sensed amperage via a wireless communications network.

17. The method of claim 12, further comprising:
receiving, via the communications interface, control input provided by the user.

18. The method of claim 17, further comprising:
enabling, via the modular device, the current based on the received control input.

19. The method of claim 17, further comprising:
disabling, via the modular device, the current based on the received control input.

20. The method of claim 19, wherein disabling, via the modular device, the current based on the received control input includes:
setting a threshold amperage corresponding to the current based on the received control input;
and
disabling the current when the sensed amperage exceeds the threshold amperage.
